(19) United States
(12) Patent Application Publication
(10) Pub. No.: US 2019/0054957 A1
(43) Pub. Date: Feb. 21, 2019

(54) VEHICLE FRAME MOUNTED DEPLOYABLE METAL BAG TO MITIGATE SIDE IMPACT CRASH INTRUSIONS

(71) Applicant: FORD GLOBAL TECHNOLOGIES, LLC, Dearborn, MI (US)

(72) Inventors: Mohammad Omar FARUQUE, Ann Arbor, MI (US); Yijung CHEN, Ypsilanti, MI (US); Dean M. JARADI, Macomb, MI (US); S. M. Iskander FAROOQ, Novi, MI (US)

(21) Appl. No.: 15/679,402

(22) Filed: Aug. 17, 2017

(51) Int. Cl. B62D 21/15; B60R 21/235; B60R 21/231; B60R 21/20; B60R 21/237

(52) U.S. Cl. CPC B62D 21/157; B60R 21/235; B60R 2021/0006; B60R 21/20; B60R 21/237; B60R 21/23138

(57) ABSTRACT

A vehicle includes a frame and a rocker panel disposed adjacent the frame and separated therefrom by a gap. The vehicle further includes a structural restraint system that includes a deployable metal bag mounted on the frame facing the rocker panel and an inflator. The structural restrain system further includes a controller configured to, responsive to sensor inputs indicative of an impact on the rocker panel, energize the inflator to inflate the deployable metal bag to fill the gap and transfer force acting on the rocker panel to the frame.

### TECHNICAL FIELD

This application is generally related to deployable metal bags between structural elements of a vehicle.

### BACKGROUND

Modern automotive vehicles utilize inflatable air bags within the cabin of the vehicle to protect occupants in the event of a collision. The air bags inflate into the cabin area in the event of a vehicle collision. The air bags limit the range and rate of movement of the occupants during a collision. The air bags are placed between the occupants and cabin surfaces to prevent the occupants from contacting the cabin surfaces during a collision.

### SUMMARY

A vehicle includes a frame, a rocker panel disposed adjacent the frame and separated therefrom by a gap. The vehicle further includes a deployable metal bag mounted on the frame facing the rocker panel and an inflator. The vehicle further includes a controller configured to, responsive to sensor inputs indicative of an impact on the rocker panel, energize the inflator to inflate the deployable metal bag to fill the gap and transfer force acting on the rocker panel to the frame.

The vehicle may further include an accelerometer configured to output an acceleration value that is in a direction generally perpendicular to the rocker panel and the frame. The accelerometer may be disposed in the controller and the controller may be further configured to detect the impact on the rocker panel in response to a magnitude of the acceleration value being greater than a predetermined threshold. The controller may be configured to receive the acceleration value via a vehicle communication network and to detect the impact on the rocker panel in response to a magnitude of the acceleration value being greater than a predetermined threshold.

A structural restraint system includes a deployable metal bag configured to mount to a frame of a vehicle and inflate into a gap between the frame and a rocker panel, an inflator, and a controller programmed to, responsive to an accelerometer input indicative of an impact to the rocker panel, cause a transfer of force acting on the rocker panel to the frame by energizing the inflator to inflate the deployable metal bag.

The controller may further include an accelerometer configured to provide the accelerometer input. The controller may be further programmed to receive the accelerometer input from an external controller via a vehicle communication network.

A vehicle includes a structural restraint system, including an inflator and a deployable metal bag, disposed on a frame opposite a rocker panel and configured to, responsive to sensor inputs indicative of an impact on the rocker panel, energize the inflator to inflate the deployable metal bag to fill a gap between the frame and the rocker panel and transfer force acting on the rocker panel to the frame.

In some configurations, the inflator may be housed within a cavity defined by the deployable metal bag. The inflator may be mounted external to the deployable metal bag and coupled to the deployable metal bag with a fill tube. The inflator may be mounted to the frame such that the inflator and the deployable metal bag are on different sides of the frame. The deployable metal bag may be accordion folded when uninflated. The deployable metal bag and the inflator may be configured so that an area and pressure of the deployable metal bag, when inflated, create at least a predetermined resistance force to prevent the rocker panel from moving toward the frame.

### BRIEF DESCRIPTION OF THE DRAWINGS

FIG. 1 depicts a vehicle with a structural restraint system.

FIG. 2 depicts a possible body-on-frame configuration of the vehicle.

FIG. 3 depicts a possible placement of a structural restraint system on a frame of the vehicle.

FIG. 4 depicts a possible arrangement of the inflator module within the deployable metal bag.

FIG. 5 depicts a possible arrangement of the inflator module outside of the deployable metal bag.

FIG. 6 depicts a possible arrangement of the inflator module on the opposite side of the frame.

FIG. 7 depicts a frame-mounted structural restraint system in an inflated state when a rocker panel is impacted by an object.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Modern vehicles are designed to prevent occupant injury in the event of a collision. A variety of safety systems are present in modern vehicles. For example, safety restraint systems may restrict the movement of occupants during a collision. In addition, supplemental restraint systems may include a cabin-mounted air bag system. The cabin-mounted air bag system may protect a driver in the event of a collision.

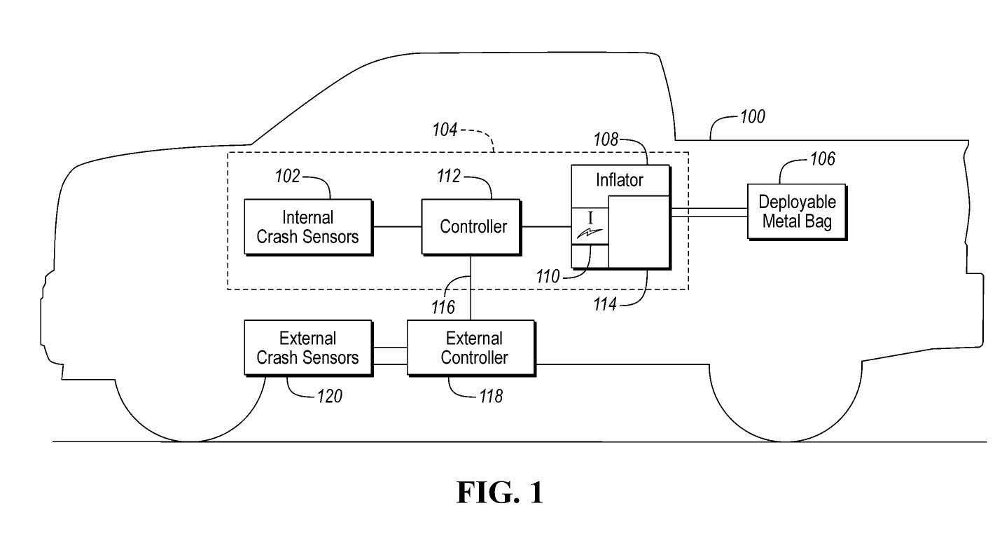

FIG. 1 depicts a vehicle 100 that includes a structural restraint system. The structural restraint system may include an inflator module 104 and a deployable metal bag 106. The inflator module may include one or more internal crash sensors 102 that are configured to detect a collision of the vehicle with an object. The internal crash sensors 102 may include one or more accelerometers. The internal crash sensors 102 may be oriented in different directions to sense forces in multiple directions. For example, an accelerometer may be configured to measure a longitudinal acceleration or force that may result from an impact to the front of the vehicle. An accelerometer may be configured to measure a lateral acceleration or force that may result from an impact on the side of the vehicle 100.

Further, the internal crash sensors 102 may be located at different positions within the vehicle 100 to detect a collision with different parts of the vehicle 100. The inflator module 104 may further include a controller 112. The internal crash sensors 102 may be electrically coupled to the controller 112.

The inflator module 104 may include an inflator unit 108. The inflator unit 108 may include a storage module 114 to store a mix of chemical compounds that are used for inflating the deployable metal bag 106. The chemical compounds may be selected to cause a rapid chemical reaction that creates gas. For example, a mixture of NaN₃, KNO₃, and SiO₂ may be used which produces N₂ gas when heated. The inflator unit 108 may include an electric ignitor 110 to trigger a temperature increase to initiate the rapid chemical reaction. Other compounds capable of creating a gas may be used without limitation.

The controller 112 may be electrically coupled to the electric ignitor 110 and may be configured to energize the electric ignitor 110 under certain conditions. The controller 112 may include driver circuitry to provide a current to the electric ignitor 110. The controller 112 may include a microprocessor along with volatile and non-volatile memory. The controller 112 may include circuitry to interface to the internal crash sensors 102.

The controller 112 may process the signals from the internal crash sensors 102 to determine when to inflate the deployable metal bag 106. For example, when an acceleration value exceeds a predetermined acceleration threshold that is indicative of a collision, the controller 112 may trigger inflation of the deployable metal bag 106. The inflator module 104 may be configured to inflate the deployable metal bag 106 to a predetermined pressure within a predetermined time. For example, the inflator module 104 may be configured to inflate the deployable metal bag 106 to a pressure of 70-100 psi in 40 milliseconds.

The controller 112 may be electrically coupled to a vehicle network 116. For example, a Controller Area Network (CAN) communication bus may be present in the vehicle 100. The vehicle 100 may include external controllers 118 that are coupled to the vehicle network 116. Further, the vehicle 100 and/or the external controllers 118 may include external crash sensors 120. The external crash sensors 120 may include one or more accelerometers configured to detect a collision. Note that the external controller 118 and the external crash sensors 120 are disposed in the vehicle 100 but external to the inflator module 104. For example, the external controller 118 may be part of a passenger cabin airbag system.

The controller 112 may be configured to receive signals from the external controller 118 via the vehicle network 116. For example, the external controller 118 may transmit accelerometer signals from the external crash sensors 120 to the controller 112. For example, the external controller 118 may send a lateral acceleration signal indicative of an amount of lateral acceleration to the controller 112. In some configurations, the external controller 118 may send a signal indicative of a side impact to the controller 112.

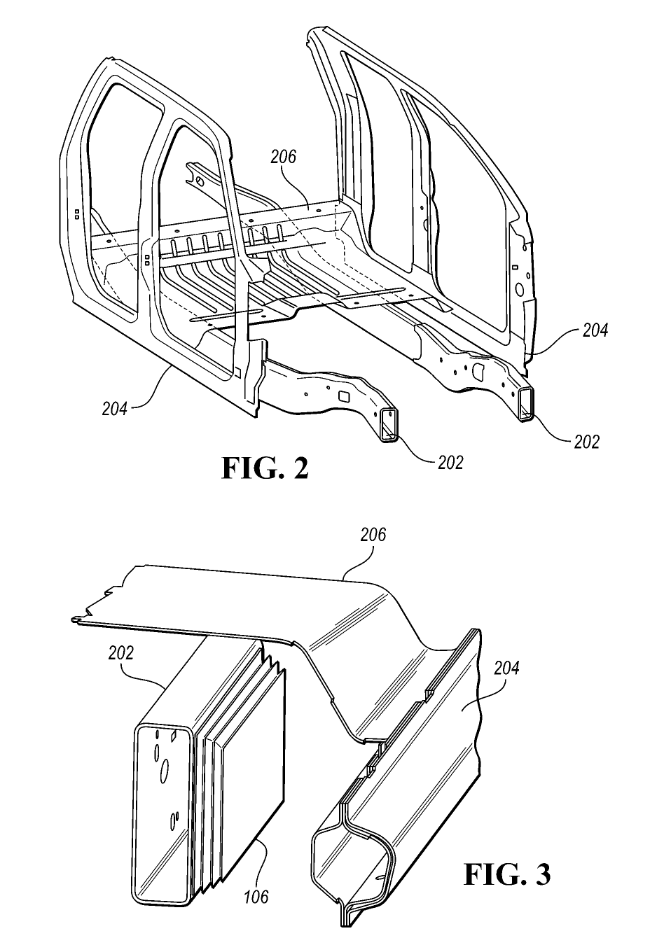

The structural restraint system described may be configured to reduce the effects of side impacts on the vehicle 100. The vehicle 100 may be a body-on-frame vehicle such as a truck. FIG. 2 depicts a possible structural configuration for a body-on-frame vehicle. The vehicle 100 may include a frame that may be comprised of one or more frame rails 202. The frame rails 202 may be joined by cross members (not shown) at various locations.

A body or cab of the vehicle 100 may include a floor pan 206 and rocker panels 204. The rocker panels 204 may be stamped pieces that are located on each side of the cab. The rocker panels 204 may extend along the bottom edge of the cab between the front and rear wheels. The rocker panels 204 may be further coupled to vertical support members that define openings of the cab. The floor pan 206 may be coupled to the rocker panels 204 on each side of the cab. The floor pan 206 may include reinforced connection points for coupling the floor pan 206 to the frame and/or frame rails 202.

A characteristic of body-on-frame vehicles is that there is a gap between the frame rail 202 and the rocker panel 204. In the event of a side collision, the impact is initially absorbed by the rocker panel 204. The frame rail 202 may begin to absorb the impact when the rocker panel 204 has deformed to a point at which contact is made with the frame rail 202. As such, the rocker panel 204 may be ineffective at stopping the intruding object until the frame rail 202 is encountered. In some cases, the object impacting the rocker panel 204 may intrude into the cab.

FIG. 3 depicts a structural restraint system including a deployable metal bag 106 disposed between the rocker panel 204 and the frame rail 202. The deployable metal bag 106 may be mounted to the frame rail 202 and configured to inflate toward the rocker panel 204.

The deployable metal bag 106 may be constructed of a metal material having high ductility. The deployable metal bag 106 may be constructed of thin sheets of metal or metal alloys. For example, materials may include copper, aluminum, stainless steel, and alloys of these materials. Three-dimensional metal printing technology may be employed to construct the deployable metal bag 106. The thickness of the material may be selected so that the deployable metal bag 106 has a high ductility. The thickness of the material may be further selected to ensure durability of the deployable metal bag 106 due the exposed location. The deployable metal bag 106 may be accordion folded in the undeployed state to allow for compact placement. The deployable metal bag 106 may be configured to expand (e.g., increase in volume) when a pressurized gas is introduced in a cavity defined by the deployable metal bag 106 (e.g., deployable metal bag 106 is hollow). The deployable metal bag 106 may be configured such that, when deployed, the volume is increased to fill a gap between the frame rail 202 and the rocker panel 204.

The deployable metal bag 106 may be coupled to a base to facilitate connection to the frame rail 202. The base may be constructed of metal or plastic. The deployable metal bag 106 may be coupled to the base with an adhesive. The base may be coupled to the frame rail 202 using adhesive and/or fasteners.

The controller may be programmed to, responsive to an accelerometer input indicative of an impact to the rocker panel 204, cause a transfer of force acting on the rocker panel 204 to the frame rail 202 by energizing the inflator 108 to inflate the deployable metal bag 106. The deployable metal bag 106 and the inflator 108 may be configured so that an area and pressure of the deployable metal bag 106, when inflated, create at least a predetermined resistance force to prevent the rocker panel 204 from moving toward the frame rail 202. For example, the force transferred to the frame rail 202 by the deployable metal bag 106 may be a function of the inflation pressure and the surface area in contact with the rocker panel 204. The predetermined resistance force may be selected to reduce the deformation of the rocker panel 204 in the event of a side collision.

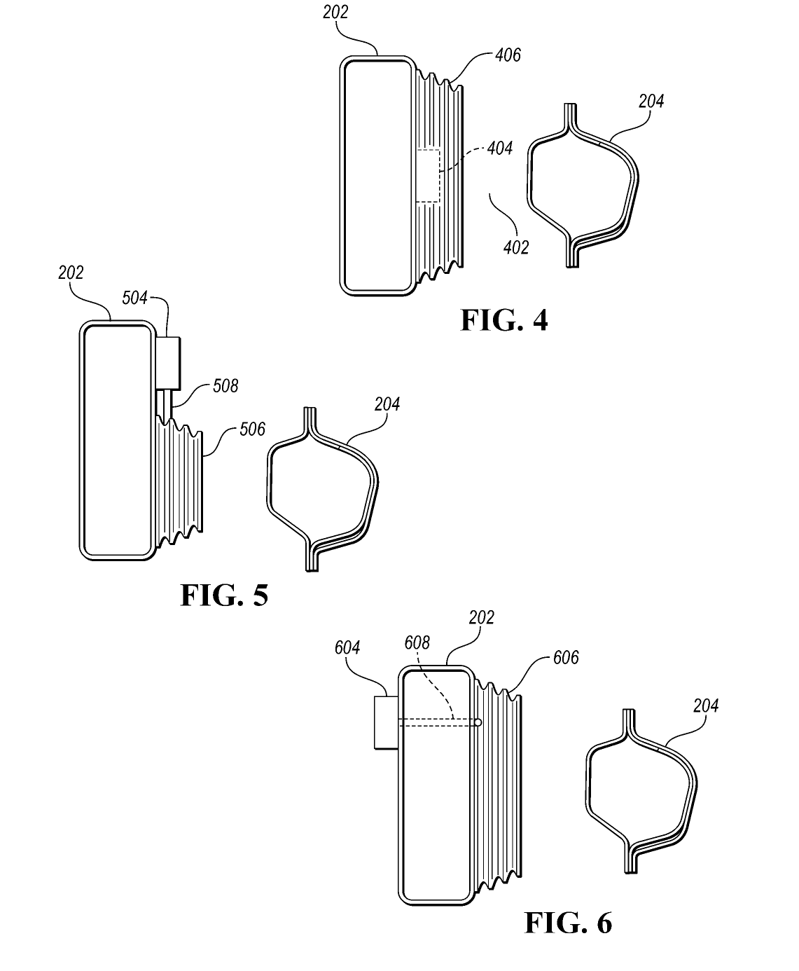

FIG. 4 depicts a cross-sectional view of the frame rail 202 and rocker panel 204 in which a structural restraint system including a deployable metal bag 406 with an internal inflator module 404 are used. The deployable metal bag 406 may be mounted on the frame rail 202 and configured to expand in the direction of the rocker panel 204 to fill the gap 402 therebetween when inflated. The internal inflator module 404 may be configured to be disposed within a cavity defined by the deployable metal bag 406. As such, the deployable metal bag 406 may be sealed around the internal inflator module 404. The deployable metal bag 406 may include a passage for wiring to/from the internal inflator module 404. For example, power and ground wires from a vehicle power source may be routed to the internal inflator module 404. The passage may be sealed around the wiring. The internal inflator module 404 may function as described in FIG. 1 (e.g. inflator module 104).

FIG. 5 depicts a cross-sectional view of the frame rail 202 and rocker panel 204 in which a structural restraint system that includes a deployable metal bag 506 with an external inflator module 504 mounted on the same side of the frame rail 202 is used. In this configuration, the external inflator module 504 may be mounted on the frame rail 202 adjacent to the deployable metal bag 506. A fill tube 508 may couple the external inflator module 504 to the deployable metal bag 506. The fill tube 508 may be metal tube configured to transfer gas from the external inflator module 504 to the deployable metal bag 506. In some configuration, the fill tube 508 may be formed from a resilient material. The external inflator module 504 may function as described in FIG. 1 (e.g. inflator module 104).

FIG. 6 depicts a cross-sectional view of the frame rail 202 and rocker panel 204 in which a deployable metal bag 606 with an external inflator module 604 mounted on an opposite side of the frame rail 202 is used. In this configuration, the external inflator module 604 may be mounted on an opposite side of the frame rail 202 as the deployable metal bag 506. That is, the external inflator module 604 is mounted on a surface of the frame rail 202 that does not face the rocker panel 204. A fill tube 608 may extend through an opening defined by the frame rail 202 to couple the external inflator module 604 to the deployable metal bag 606. The fill tube 608 may be metal tube configured to transfer gas from the external inflator module 604 to the deployable metal bag 606. A possible benefit of this configuration is that the external inflator module 604 may be offered greater protection by the frame rail 202 to prevent damage before full deployment of the deployable metal bag 606. The configuration selected may depend upon packaging space along the frame rails 202.

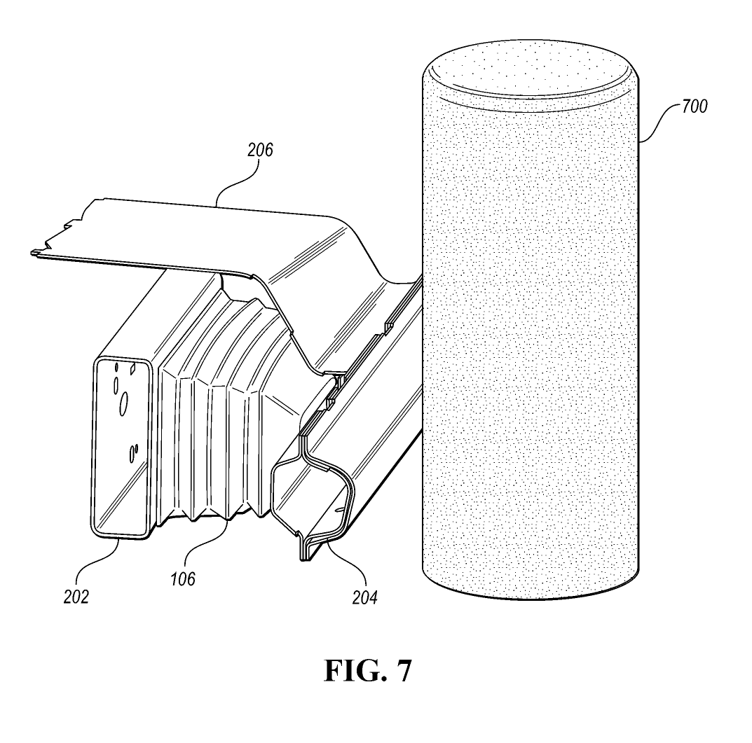

FIG. 7 depicts the deployable metal bag 106 in an inflated state as may occur after detecting a side collision in which an object 700 contacts the rocker panel 204. In the event of a side collision with the object 700, the deployable metal bag 106 is inflated. The controller 112 may monitor the signals from the internal crash sensors 102 and/or the external crash sensors 120 to determine if a side impact is occurring. For example, an accelerometer signal corresponding to a lateral acceleration component may be monitored. The controller 112 may filter the signal over a predetermined time interval to prevent false triggers. If the signal and/or filtered signal exceeds a threshold that is indicative of a side impact (e.g., greater than 2g), then the controller 112 may energize the inflator 108 to trigger inflation of the deployable metal bag 106. Inflation of the deployable metal bag 106 cause the deployable metal bag 106 to expand to fill the gap between the frame rail 202 and the rocker panel 204. When inflated, the deployable metal bag 106 provides a force to resist the movement of the rocker panel 204 toward the frame rail 202. In doing so, intrusion of the object 700 into the occupant cabin may be reduced.

The internal crash sensors 102 and/or the external crash sensors 120 may include an accelerometer that is configured to output an acceleration value that is in the direction generally perpendicular to the rocker panel 204 and the frame rail 202. A magnitude of the acceleration value in the lateral direction that exceeds a predetermined threshold may be indicative of an impact to the rocker panel 204. The controller 112 may detect an impact on the rocker panel 204 in response to the magnitude of the acceleration value being greater than the predetermined threshold.

The advantages of the frame-mounted structural restraint system include providing an effective lateral load transfer structure between the frame and the rocker panels to mitigate side intrusion in side impact scenarios. As such, the system may mitigate harm caused to occupants due to side intrusions. In addition, the system provides a weight efficient solution and packages easily into existing body-on-frame vehicle applications.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a frame;
a rocker panel disposed adjacent the frame and separated therefrom by a gap;
a deployable metal bag mounted on the frame facing the rocker panel;
an inflator; and
a controller programmed to, responsive to sensor inputs indicative of an impact on the rocker panel, energize the inflator to inflate the deployable metal bag to fill the gap and transfer force acting on the rocker panel to the frame.

2. The vehicle of claim 1 wherein the inflator is housed within a cavity defined by the deployable metal bag.

3. The vehicle of claim 1 wherein the inflator is mounted external to the deployable metal bag and coupled to the deployable metal bag with a fill tube.

4. The vehicle of claim 3 wherein the inflator is mounted to the frame such that the inflator and the deployable metal bag are on different sides of the frame.

5. The vehicle of claim 1 wherein the deployable metal bag is accordion folded when uninflated.

6. The vehicle of claim 1 wherein the deployable metal bag and the inflator are configured so that an area and pressure of the deployable metal bag, when inflated, create at least a predetermined resistance force to prevent the rocker panel from moving toward the frame.

7. The vehicle of claim 1 further comprising an accelerometer configured to output an acceleration value that is in a direction that is generally perpendicular to the rocker panel and the frame.

8. The vehicle of claim 7 wherein the accelerometer is disposed in the controller and the controller is further configured to detect the impact on the rocker panel in response to a magnitude of the acceleration value being greater than a predetermined threshold.

9. The vehicle of claim 7 wherein the controller is configured to receive the acceleration value via a vehicle communication network and to detect the impact on the rocker panel in response to a magnitude of the acceleration value being greater than a predetermined threshold.

10. A structural restraint system comprising:
a deployable metal bag configured to mount to a frame of a vehicle and inflate into a gap between the frame and a rocker panel;
an inflator; and
a controller programmed to, responsive to an accelerometer input indicative of an impact to the rocker panel, cause a transfer of force acting on the rocker panel to the frame by energizing the inflator to inflate the deployable metal bag.

11. The structural restraint system of claim 10 wherein the inflator is housed within a cavity defined by the deployable metal bag.

12. The structural restraint system of claim 10 wherein the inflator is mounted external to the deployable metal bag and coupled to the deployable metal bag with a fill tube.

13. The structural restraint system of claim 10 wherein the deployable metal bag is accordion folded when uninflated.

14. The structural restraint system of claim 10 wherein the deployable metal bag and the inflator are configured so that an area and pressure of the deployable metal bag, when inflated, create at least a predetermined resistance force to prevent the rocker panel from moving toward the frame.

15. The structural restraint system of claim 10 wherein the controller further includes an accelerometer configured to provide the accelerometer input.

16. The structural restraint system of claim 10 wherein the controller is further programmed to receive the accelerometer input from an external controller via a vehicle communication network.

17. A vehicle comprising:
a structural restraint system, including an inflator and a deployable metal bag, disposed on a frame opposite a rocker panel and configured to, responsive to sensor inputs indicative of an impact on the rocker panel, energize the inflator to inflate the deployable metal bag to fill a gap between the frame and the rocker panel and transfer force acting on the rocker panel to the frame.

18. The vehicle of claim 17 wherein the inflator is mounted external to the deployable metal bag and coupled to the deployable metal bag with a fill tube.

19. The vehicle of claim 18 wherein the inflator is mounted to the frame such that the inflator and the deployable metal bag are on different sides of the frame.

20. The vehicle of claim 17 wherein the inflator is housed within a cavity defined by the deployable metal bag.
